(19) United States
(12) Patent Application Publication
(10) Pub. No.: US 2023/0416531 A1
(43) Pub. Date: Dec. 28, 2023

(54) PIGMENTABLE NON-ASPHALTIC SEALANT COMPOSITIONS AND METHODS FOR IMPROVED LOW TEMPERATURE PROPERTIES

(71) Applicant: ADVETUS MATERIAL STRATEGIES, LLC, DANIEL ISLAND, SC (US)

(72) Inventors: Joseph Drbohlav, III, Inman, SC (US); Brian J. Majeska, Mount Pleasant, SC (US); Joseph L. Lorenc, Philadelphia, PA (US)

(21) Appl. No.: 18/212,336

(22) Filed: Jun. 21, 2023

Related U.S. Application Data
(60) Provisional application No. 63/354,822, filed on Jun. 23, 2022.

(51) Int. Cl. C08L 93/04; C08J 3/20

(52) U.S. Cl. CPC C08L 93/04; C08J 3/203; C08L 2205/02; C08J 2391/00; C08J 2491/00; C08J 2393/04; C08J 2493/04

(57) ABSTRACT

A pigmentable non-asphaltic composition for use as a sealant for cracks and joints in pavement surfaces, and for other purposes, and a method of forming the composition wherein (a) the composition comprises a non-asphaltic base blend which uses one or more tree rosin esters and (b) the low temperature properties of the composition, such as ductility and flexural creep stiffness, are enhanced by incorporating distilled tall oil and/or other low temperature property enhancing additives.

### RELATED CASE

This application claims the benefit of U.S. Provisional Patent Application No. 63/354,822 filed Jun. 23, 2022 and incorporates said provisional application herein by reference in its entirety as if fully set forth at this point.

### FIELD OF THE INVENTION

The present invention relates to hot-applied non-asphaltic sealant compositions, methods of production, and methods of use for sealing cracks and joints in roads, parking lots, sidewalks, and other pavement substrates, and also relates to improvements in non-asphaltic compositions for pavement markings, pothole repair mixtures, and dense and gap-graded mixtures of aggregates and pigmentable non-asphaltic binders.

### BACKGROUND OF THE INVENTION

For some hot-applied sealant applications, it is beneficial to have a sealant that can be pigmented to a color that matches the substrate to which it is applied. Unfortunately, the pigmented and non-pigmented colors of asphalt-based sealants are generally limited to black or brown. However, hot-applied non-asphaltic sealant compositions, formed from non-asphalt base resin materials, are available which can be pigmented to virtually any color, including even the gray color of Portland cement concrete.

As with hot-applied asphalt compositions, hot-applied non-asphaltic crack and joint sealants must meet several performance parameters in order to be effective for waterproofing cracks and joints in pavement surfaces. One such parameter is the ring and ball softening point of the hot-applied sealant material. A minimum ring and ball softening point is needed to ensure that the sealant will not flow at high in-service temperatures. A hot-applied non-asphaltic sealant composition will preferably have a softening point for most applications of about 80° C. or higher, with a softening point of at least 85° C. being more preferred.

Another important performance parameter is the viscosity of the hot-applied sealant material. The sealant material must have a viscosity that allows it to flow into cracks and coat the substrate at reasonable application temperatures, typically in the range of from 350° F. to 400° F. The rotational viscosity of a hot-applied non-asphaltic sealant composition will typically be in the range of 5500-7000 cps at 350° F., with viscosities below 5500 cps being more preferred and viscosities below 5000 cps being most preferred at 350° F.

Another important performance parameter is the “resilience” of the sealant material as determined in accordance with ASTM D5329. The ASTM D5329 resilience test for hot-applied crack and joint sealant compositions measures the ability of the sealant composition to resist a solid, hard object (e.g., a rock) which is pressed into the surface of the applied material. The resilience of a sealant material is analogous to the elastic recovery of an asphalt binder, i.e., the ability of the asphalt to recover its shape quickly after being deformed. It is preferred that a hot-applied non-asphaltic crack and joint sealant have a resilience of at least 50% when measured according to ASTM D5329. More preferably, the resilience of the non-asphaltic sealant material will be at least 60% and will most preferably be 70% or greater.

Yet another important performance parameter is the “ductility” of the hot-applied sealant material. A hot-applied crack and joint sealant must demonstrate the ability to undergo stretching or elongation without breaking. This tensile property of a sealant, referred to as “ductility”, is more severe when measured at colder temperatures. To ensure adequate tensile strength and flexibility at low temperatures, a hot-applied non-asphaltic crack and joint sealant should have a ductility at 4° C. of at least 30 cm when measured in accordance with ASTM D113. More preferably, the sealant will have a minimum ductility at 4° C. of at least 40 cm.

The hot-applied non-asphaltic crack and joint sealant will preferably also be resistant to fracturing when exposed to thermally induced shrinkage stresses at low temperatures. Preferably, an unaged non-asphaltic sealant will ideally have a flexural (bending) creep stiffness of 25 MPa or less as measured using a Bending Beam Rheometer (BBR) at −12° C. and at a loading time of 240 seconds according to AASHTO T338.

Unfortunately, the low temperature properties of the hot-applied non-asphaltic crack and joint sealants heretofore used in the art have typically been less that satisfactory or have been inadequate. For example, the ductilities, as measured at 4° C., have been low and the BBR flexural creep stiffnesses of these prior non-asphaltic sealant compositions have fallen short of the ideal performance values discussed above.

Consequently, a need exists for a pigmentable, hot-applied, non-asphaltic crack and joint sealant composition in which (a) the viscosity of the composition and its softening point and resilience are maintained within the preferred ranges discussed above or are improved and (b) the low temperature properties of the composition such as its 4° C. ductility and its BBR flexural creep stiffness are improved.

### SUMMARY OF THE INVENTION

The present invention provides a pigmentable, hot-applied non-asphaltic sealant composition and method which alleviate the problems and satisfy the needs mentioned above. We have discovered that the addition of distilled tall oil, a distilled tall oil blend, and/or other Low Temperature Property enhancing (LTP) additive as disclosed herein to a non-asphaltic sealant base resin produced by the esterification of a tree rosin material will (a) surprisingly and unexpectedly improve the low temperature properties of the composition such as its 4° C. ductility and flexural creep stiffness and also (b) provide improved viscosity and resilience.

Moreover, we have also discovered that whereas the addition of the other LTP additives disclosed herein can in some cases cause a significant reduction in the softening point of the composition, the softening point of the composition will not be significantly reduced by the addition of distilled tall oil. Rather, with the addition of distilled tall oil, the softening point of the non-asphaltic sealant composition will surprisingly and unexpectedly be maintained at a desired level as discussed above.

In addition, the inventive non-asphaltic sealant composition is fully pigmentable to match any pavement substrate color, including Portland cement concrete.

In one aspect, there is provided a method of producing a non-asphaltic sealant composition for cracks and joints in pavements and other substrates, wherein the non-asphaltic sealant composition will provide improved low temperature properties and improved viscosity and resilience. The method preferably comprises the steps of: (a) forming a non-asphaltic sealant base blend comprising an esterified tree rosin material, processing oil, and one or more plasticizers, wherein the non-asphaltic sealant base blend is formed at a sufficient temperature, and with agitation, stirring, and/or mixing, to melt the esterified tree rosin material and incorporate the esterified tree rosin material into the processing oil and (b) adding distilled tall oil, a distilled tall oil blend, and/or other LTP additive to the non-asphaltic sealant base blend during or after step (a).

In another aspect, to improve the low temperature properties, viscosity, and resilience of the non-asphaltic sealant composition while maintaining, improving, or at least not significantly reducing the softening point of the composition, the LTP additive used in step (b) will preferably be distilled tall oil or a distilled tall oil blend.

In another aspect, the method can further comprise the steps, after step (a) and after or before step (b), of: (c) at least partially neutralizing a non-white shade or color of the non-asphaltic sealant base blend, to produce an at least partially color-neutralized base blend, by adding one or more color-neutralizing materials to the non-asphaltic sealant base blend (the one or more color-neutralizing materials preferably comprising titanium dioxide); (d) adding one or more pigment materials to form a pigmented base blend; and/or (e) adding one or more elastomeric polymer materials.

In another aspect, there is provided a method for forming, and enhancing low temperature properties of, a non-asphaltic composition for use as a hot-applied sealant, or for pavement markings, or for use as a binder for aggregates for filling potholes and road repairs. The method preferably comprises the steps of: (a) forming a non-asphaltic base blend by heating and blending (i) one or more processing oils in a total amount in a range of from 5% to 35% by weight based on a total weight of the non-asphaltic composition, (ii) one or more plasticizers in a total amount in a range of from 0.5% to 6% by weight based on the total weight of the non-asphaltic composition, and (iii) one or more tree rosin esters in a total amount in a range of from 25% to 80% by weight based on the total weight of the non-asphaltic composition and (b) incorporating, during and/or after step (a), a low temperature property enhancing additive. The low temperature property enhancing additive is preferably incorporated in a total amount, in a range of from 1% to 25% by weight based on the total weight of the non-asphaltic composition, which increases a 4° C. ductility and decreases a flexural creep stiffness of the non-asphaltic composition. The low temperature property enhancing additive is preferably a distilled tall oil, a distilled tall oil blend, one or more vegetable oils, or a combination thereof.

In another aspect, there is provided a non-asphaltic sealant composition having improved low temperature properties, improved viscosity, and improved resilience for sealing cracks and joints in pavements and other substrates. The non-asphaltic sealant composition preferably comprises: (a) a non-asphaltic sealant base blend which comprises a total of from 5 to parts by weight (pbw) of one or more processing oils, a total of from 0.5 to 6 pbw of one or more plasticizers, and a total of at least 25 pbw of one or more esterified tree rosin materials which is/are melted and incorporated in the one or more processing oils and (b) distilled tall oil, a distilled tall oil blend, and/or other LTP additive in a total amount of from 1 to 25 pbw.

In another aspect, the non-asphaltic sealant composition can also comprise: (c) a total of from 1 to 25 pbw of titanium dioxide and/or one or more other color neutralizing materials which at least partially neutralize a non-white shade or color of the non-asphaltic sealant base blend; (d) a total of from 0.2 to 2 pbw of one or more other pigment materials which impart a non-white color or shade to the non-asphaltic sealant composition; and/or (e) a total of from 2 to pbw of one or more elastomeric polymer materials.

In another aspect, examples of further materials which can optionally be included in the non-asphaltic sealant composition include, but are not limited to, a crumb rubber modifier and/or one or more inorganic fillers.

In another aspect, there is provided a non-asphaltic composition for use as a hot-applied sealant, or for pavement markings, or for use as a binder for aggregates for filling potholes and road repairs. The non-asphaltic composition preferably comprises: (a) a non-asphaltic base blend which includes (i) one or more processing oils in a total amount in a range of from 5% to 35% by weight based on a total weight of the non-asphaltic composition, (ii) one or more plasticizers in a total amount in a range of from 0.5% to 6% by weight based on the total weight of the non-asphaltic composition, and (iii) one or more tree rosin esters in a total amount in a range of from 25% to 80% by weight based on the total weight of the non-asphaltic composition and (b) a low temperature property enhancing additive. The low temperature property enhancing additive is preferably (i) incorporated when and/or after the non-asphaltic base blend is formed, (ii) selected from a distilled tall oil, a distilled tall oil blend, one or more vegetable oils, or a combination thereof, and (iii) included in the non-asphaltic composition in a total amount, in a range of from 1% to 25% by weight based on the total weight of the non-asphaltic composition, which increases a 4° C. ductility and decreases a flexural creep stiffness of the non-asphaltic composition.

Further aspects, features, and advantages of the present invention will be apparent to those in the art upon reading the following detailed description of the preferred embodiments.

### DETAILED DESCRIPTION OF THE PREFERRED EMBODIMENTS

The hot-applied non-asphaltic sealant composition provided by the present invention preferably comprises a non-asphaltic sealant base blend which includes: a total amount of one or more tree rosin esters in the range of from 25% to 80% by weight of the total final weight of the non-asphaltic sealant composition; a total amount of one or more processing oils in the range of from 5% to 35% by weight of the total weight of the non-asphaltic sealant composition; and a total amount of one or more plasticizers in the range of from 0.5% to 6% by weight of the total weight of the non-asphaltic sealant composition. In addition, a distilled tall oil, a blend of distilled tall oil products, one or more other LTP additives, or a combination thereof is added to the non-asphaltic sealant base blend in a total amount in the range of from 1% to 25% by weight of the total weight of the non-asphaltic sealant composition.

The inventive hot-applied non-asphaltic sealant composition preferably also comprises: a total amount of one or more polymers in the range of from 2% to 20% by weight of the total weight of the non-asphaltic sealant composition; a total amount of one or more color neutralizing materials, if used, in the range of from 1% to 25% by weight of the total weight of the non-asphaltic sealant composition; an amount of one or more other pigment materials, if used, in the range of from 0.1% to 6% by weight of the total weight of the non-asphaltic sealant composition; an optional amount of a crumb rubber modifier in the range of from 0% to 15% by weight based upon the total weight of the non-asphaltic sealant composition; and a total amount of one or more inorganic fillers, if used, in the range of from 3% to 30% by weight of the total weight of the non-asphaltic sealant composition.

The total amount of the one or more tree rosin esters used in the inventive non-asphaltic sealant composition will more preferably be in the range of from 25% to 60% by weight and will more preferably be in the range of from 40% to 55% by weight of the total weight of the non-asphaltic sealant composition. The total amount of the tall oil distillate, tall oil distillate blend, and/or one or more other LTP additives used in the inventive non-asphaltic sealant composition will more preferably be in the range of from 1% to 15% and will more preferably be in the range of from 2% to 7% by weight of the total weight of the non-asphaltic sealant composition.

Each of the one or more tree rosin esters used in the inventive non-asphaltic sealant composition will preferably be an amorphous, esterified (preferably glycol esterified) mixture of low molecular weight compounds produced from the pulping or processing of wood. Tree rosin ester materials typically have softening points of greater than 50° C. and needle penetration values of near 0 dmm at 25° C. The tree rosin ester material(s) used in the inventive non-asphaltic sealant composition will preferably have (a) a softening point in the range of from about 80° C. to about 120° C., more preferably from about 95° C. to about 110° C., and (b) an acid number of less than 20 mg/g and more preferably less than 15 mg/g.

Examples of tree rosin ester materials suitable for use in the inventive non-asphaltic sealant composition include, but are not limited to, pine-based pentaerythritol ester resins and pine-based glycerol ester resins. The rosin ester material will preferably be or comprise a pine-based pentaerythritol ester resin. An example of a commercially available pine-based pentaerythritol ester resin is WESTREZ Rosin Ester 5101 produced by Ingevity of Charleston, SC.

Distilled tall oil is a sustainable material made from a renewable source, preferably pine trees. It is comprised of rosin acids and fatty acids. By way of example, but not by way of limitation, distilled tall oil can be produced by a process wherein: (i) a Kraft paper mill is operated to produce pulp and paper from pine trees along with a black liquor co-product and a turpentine co-product; (ii) the black liquor is cooled to concentrate the rosin and fatty acids therein in a top soap layer which is skimmed off; (iii) the soap layer is treated with sulfuric acid to form crude tall oil; and (iv) the crude tall oil is fractionated using a distillation process under vacuum. The fractionation of the crude tall oil yields five products which, in order of increasing boiling point, include: (1) a tall oil heads product, (2) a fatty acids fraction, (3) distilled tall oil, (4) a tall oil rosin fraction, and (5) tall oil pitch.

Due to the variable nature of the proportions of the rosin acids and fatty acids found in different pine tree or other tree source materials, as well as variations in the cut points which may be selected when fractionating crude tall oil, the compositions of distilled tall oil products can vary such that the concentration of rosin acid found in a distilled tall oil product will typically be in the range of from 10% to 50% by weight of the total weight of the distilled tall oil product. A distilled tall oil product will more typically comprise from 10% to 40% by weight rosin acids and from 60% to 90% by weight fatty acids based upon the total weight of the distilled tall oil product.

The rosin acids contained in distilled tall oil products will typically include one of, and will more typically include both of, abietic acid and pimaric acid. The fatty acids contained in distilled tall oil products will typically include some of, and will more typically include all of, palmitic acid, stearic acid, oleic acid, linoleic acid, and linolenic acid.

By way of example, but not by way of limitation, an example of a commercially available, pine tree-based distilled tall oil product suitable for use in the inventive hot-applied non-asphaltic sealant composition is ALTAPYNE M-28B produced by Ingevity of Charleston, SC. ALTAPYNE M-28B has (a) a maximum rosin acid content of 35% by weight (typically 28%), (b) a dark amber or brown color, (c) a melting point of −20.15° C. (−4.3° F.), (d) a boiling point of 360.85° C. (681.5° F.), (e) a closed cup flash point of 207.2° C. (405° F.), (f) a Cleveland open cup flash point of 207.22° C. (405° F.), (g) an auto-ignition temperature of >365° C. (>689° F.), (h) a dynamic viscosity (room temperature) of 203 to 825 mPa*s, (i) a kinematic viscosity (40° C.) of 0.441 cm²/s, (j) a relative density of 0.942 [water=1], and (k) an n-Octanal/Water partition coefficient of from 3.2 to 6.8.

Due to the stiff and brittle nature of tree rosin ester materials, the one or more tree rosin esters used in the inventive non-asphaltic sealant composition are preferably blended with one or more processing oils in a total amount as indicated above. The processing oil used in forming the non-asphaltic sealant resin base blend of the inventive composition will preferably comprise one or more aromatic, naphthenic, paraffinic, and/or vegetable oils. The processing oil will preferably (a) be effective for blending with the one or more tree rosin ester materials to produce a softening point of the base blend in the range of from about 40° to about 70° C. and a needle penetration value of the base blend in the range of from about 20 to about 80 dmm at and (b) have an aromatic content of at least 40% by weight, or at least 45%, 50%, 55%, 60%, 65% or 70% by weight, based upon the total weight of the processing oil.

Examples of commercially available processing oils which are well suited for blending with pine-based pentaerythritol resins and other tree rosin ester materials are SUNDEX 165 (an aromatic processing oil having a molecular weight of 588 and an aromatic content of 55% by weight based upon the total weight of the SUNDEX 165) and HYDROLENE LPH. SUNDEX 165 and HYDROLENE LPH are available from HollyFrontier Lubricants and Specialty Products of Tulsa, OK.

Although the total amount of the one or more processing oils used in the inventive hot-applied non-asphaltic composition can be as low as 5% by weight or less, the total percent by weight of the one or more processing oils used in the composition will more preferably be at least 10% and will more preferably be in the range of from 20% to 30% by weight of the total weight of the non-asphaltic sealant composition.

The one or more polymers used in the inventive non-asphaltic sealant composition will preferably be one or more elastomeric polymer materials. Although, if used, the total amount of the one or more polymers added to the inventive hot-applied non-asphaltic sealant composition can be as low as 2% or less, the total percent by weight of the one or more polymers used in the inventive sealant composition will more preferably be at least 6% and will more preferably be in the range of from 8% to 16% by weight of the total weight of the non-asphaltic sealant composition.

Examples of elastomeric polymer materials suitable for use in the inventive non-asphaltic sealant composition include, but are not limited to: styrene block copolymers such as radial and/or linear styrene butadiene styrene (SBS) block copolymers, styrene butadiene copolymers, styrene isoprene copolymers, and styrene isoprene styrene (SIS) block copolymers; ethylene vinyl acetate (EVA); polymers such as ethylene-propylene-diene monomer rubber (EPDM) formed by the copolymerization of ethylene and propylene with suitable monomers to disrupt crystallinity; acrylic copolymers and terpolymers such as butyl acrylate and glycidyl methacrylate, which are derived from copolymerization of ethylene with acrylic monomers; and combinations thereof. The one or more elastomeric polymer materials will preferably comprise an SBS polymer and/or an SIS polymer and will more preferably comprise a radial SBS polymer.

Although the total amount of the one or more plasticizers used in forming the base blend of the hot-applied non-asphaltic sealant composition can be as low as 0.5% by weight or less, the total amount of the one or more plasticizers used in forming the base blend of the non-asphaltic composition will more preferably be at least 1.0% or at least 1.5% by weight of the total weight of the non-asphaltic sealant composition and will more preferably be in the range of from 2% to 4% by weight of the total weight of the non-asphaltic sealant composition.

The one or more plasticizers used in forming the base blend of the inventive hot-applied non-asphaltic sealant composition will preferably have or provide: (i) a molecular weight of less than 1000 g/mole and more preferably less than 500 g/mole; (ii) a boiling point at atmospheric pressure of greater than 250° C. and more preferably greater than 300° C.; (iii) a vapor pressure at 25° C. of less than 1 mmHg and more preferably less than 0.1 mmHg; (iv) chemical compatibility with the primary base resin (i.e. the plasticizer used for forming the base blend will preferably be fully miscible in the base resin and form a stable, homogeneous solution when added to the base resin); and (v) chemical compatibility with the polymer modifier(s) (i.e. the polymer(s) will preferably swell when placed in a volume of the plasticizer).

The one or more plasticizing materials used in forming the base blend of the inventive hot-applied non-asphaltic sealant composition will preferably comprise one or more epoxidized esters of vegetable oils (also referred to as functionalized esters derived from vegetable oil fatty acids). Examples of epoxidized esters of vegetable oils suitable for use in forming the non-asphaltic sealant include, but are not limited to, epoxidized esters of soybean oil, corn oil, tall oil, and sunflower oil. The epoxidized ester of vegetable oil will preferably be an epoxidized ester of soybean oil and will most preferably be an epoxy functionalized methyl ester of soybean oil. Examples of other epoxidized esters of soybean oil suitable for use in the present invention include, but are not limited to, benzyl, propyl, and ethyl esters of soybean oil.

Examples of other types of plasticizers suitable for use in forming the base blend of the inventive hot-applied non-asphaltic sealant composition include, but are not limited to, esters derived from vegetable oil fatty acids, esters and diesters derived from the esterification of fatty alcohols and carboxylic acids, or from the esterification of alcohols with fatty acids, hydrogenated and non-hydrogenated aromatic oils and related petroleum distillates, hydrogenated and non-hydrogenated naphthenic oils and related petroleum distillates, and paraffinic oils and distillates.

Examples of inorganic fillers suitable for use in the inventive pigmentable non-asphaltic sealant composition include, but are not limited to, titanium dioxide, ferric oxide, talc, calcium carbonate, fly ash, silica, alumina-based inorganic materials, and combinations thereof.

If added, the titanium dioxide filler used in the inventive non-asphaltic sealant composition will preferably be rutile TiO₂ having an alumina or silica coating for improved dispersibility and oil absorption. Rutile titanium dioxide particles of the type treated with an organic coating to further promote dispersion in oil-based media are also preferred.

If added, the ferric oxide filler used in the inventive non-asphaltic sealant composition will preferably be a particulate ferric oxide having a fine particle size of 5 microns or less, and more preferably 1 micron or less, which is well suited for effective dispersion and pigmenting effect.

In accordance with the method of the present invention, the sealant base blend is preferably produced by: (i) heating the processing oil to a blending temperature in the range of from about 275° F. to about 350° F. (more preferably from about 320° to about 330° F.) while applying low shear agitation or mixing; (ii) adding the one or more plasticizers to the heated processing oil with low shear agitation or mixing and with continued heating as required to maintain the blending temperature; (iii) adding the tree rosin ester material with low shear agitation or mixing and with continued heating to maintain the blending temperature; and then (iv) continuing to agitate or mix the resulting blend at the blending temperature until the tree rosin ester material is melted and fully incorporated in the processing oil.

The distilled tall oil, the distilled tall oil blend, and/or other LTP additive(s) used in the inventive hot-applied non-asphaltic sealant composition can generally be added at any point, or can be divided for addition at two or more different points, of the inventive method for forming the inventive sealant composition. The distilled tall oil, the distilled tall oil blend, and/or other LTP additive(s) will preferably be added (a) during or after the formation of the sealant base blend (i.e., prior to the addition of any color-neutralizing, pigmenting, polymer, or other non-base materials) using low shear agitation at a blending temperature of from about 275° F. to about 350° F. to form a homogeneous mixture or (b) at the conclusion of the inventive method following the addition of the polymer material. The distilled tall oil, the distilled tall oil blend, and/or other LTP additive(s) will preferably be added during or after the formation of the sealant base blend prior to adding the other non-base materials of the inventive composition.

As noted above, although distilled tall oil is most preferred for use in the inventive composition and method in order to also provide superior softening point properties, all or a portion of the distilled tall oil can be replaced by the addition of one or more other Low Temperature Property enhancing (LTP) additives. The one or more other LTP additives can, for example, be any of the one or more plasticizers listed above for use in forming the base blend of the inventive non-asphaltic sealant composition. However, examples of other LTP additives which are more preferred for use in the inventive composition and method as substitutes for all or a portion of the distilled tall oil include, but are not limited to, crude soybean oil, corn oil, sunflower oil, rapeseed oil, cottonseed oil, other vegetable oils, and combinations thereof. If one or more of these preferred substitute LTP additives is/are used in the inventive composition and method to replace the distilled tall oil, the total amount of the one or more substitute LTP additives will preferably be in the range of from 1% to 15% by weight and will more preferably be in the range of from 2% to 7% by weight of the total weight of the inventive non-asphaltic sealant composition.

The sealant base blend will typically have a non-white shade or color. The non-white shade or color of the sealant base blend will preferably be at least partially neutralized, more preferably substantially or entirely neutralized, prior to pigmenting the inventive composition to its desired final color. The non-white shade or color of the sealant base blend will preferably be significantly or entirely neutralized by: (1) maintaining the blending temperature of the sealant base blend while adding titanium dioxide thereto with mixing and (2) continuing to maintain the blending temperature of the sealant base blend while adding calcium carbonate and/or any other color-neutralizing materials thereto with mixing. Although high shear and/or high speed mixing may be needed in some circumstances, maintaining the temperature of the base blend in the range of from 300° F. to 350° F. will typically allow low speed and/or low shear mixing to be used for incorporating and dispersing the TiO₂ and any additional color-neutralizing materials.

When needed for incorporating the titanium dioxide and/or other color-neutralizing materials, high shear mixing can more effectively overcome the forces of attraction between adjacent TiO₂ or other particles, thereby more readily breaking up and dispersing TiO₂ or other agglomerates into separate particles.

As used herein, the term “high speed and/or high shear” means the use of mixing equipment that provides a high rate of rotation of typically in excess of 1000 rotations per minute (rpm) and more typically in excess of 2000 rpm. The high shear mixing also forces the material through a small or narrow gap, thus imparting relatively high levels of shear stress to the material and helping to break apart and disperse agglomerations.

Examples of devices and systems suitable for high speed and/or high shear mixing of the inventive composition include, but are not limited to, Silverson® laboratory mixers with high shear milling heads, rotor-stator mills, and Cowles mixers.

As used herein, the term “low speed and/or low shear” means a speed of less than 1000 rpm, more preferably less than 750 rpm, and more preferably 500 rpm or less. Examples of suitable low speed mixing devices or systems include, but are not limited to, low speed paddle mixers or agitators.

In many cases, even after the addition of titanium dioxide and calcium carbonate to the sealant base blend, a slight yellow color will remain. As an additional color neutralizing agent for neutralizing the remaining yellow color, a blue pigment will preferably also be added to the sealant base blend in an amount in the range of from about 0.1% to about 5% by weight, more preferably from about 0.5% to about 2% by weight, based upon the total final weight of the inventive pigmented sealant composition after the distilled tall oil, the titanium dioxide, the calcium carbonate, the blue pigment, any additional color-neutralizing materials, the one or more pigment materials, any filler material, and the one or more elastomeric polymer materials have been added to the sealant base blend.

In the next step of the inventive method, the at least partially color-neutralized sealant base blend is pigmented to achieve generally any non-white shade or color desired for the final pigmented composition. In accordance with the inventive method, the at least partially color-neutralized sealant base blend will preferably be pigmented by (1) continuing to maintain the neutralized sealant base blend at the blending temperature while (2) adding one or more pigment materials to the neutralized sealant base blend with mixing. Although high shear and/or high speed mixing may be needed in some circumstances, maintaining the temperature of the color-neutralized base blend in the range of from 300° F. to 350° F. will typically allow low speed and/or low shear mixing to be used for incorporating and dispersing the one or more pigment materials.

The one or more pigment materials can be generally any heat-stable pigment(s). Examples of pigment materials suitable for use in the inventive composition to achieve desired end colors include, but are not limited to, gray pigments such as Gilsonite and red pigments such as iron oxides and hydrates of iron oxide salts.

The one or more pigment materials will preferably be added to the at least partially neutralized sealant base blend as needed to achieve the desired end color. The one or more pigment materials will typically be added in a total amount in the range of from 0.1% to about 6% by weight, more typically from about 0.3% to about 4% by weight, based upon the total final weight of the inventive pigmented sealant composition after the distilled tall oil, the titanium dioxide, any additional color-neutralizing materials, the one or more pigment materials, any filler material, and the one or more elastomeric polymer materials have been added to the sealant base blend.

As will be understood by those skilled in the art, pigments sometimes include carrier materials. Consequently, as used herein and in the claims, a weight amount or percentage amount or concentration stated for any color-neutralizing material or pigment material used in the inventive composition includes any carrier material which is contained in the color-neutralizing or pigment material.

The use of Gilsonite powder in the pigmenting step has shown to be particularly effective in achieving a gray tone similar or identical to Portland cement concrete.

In accordance with the inventive method, the one or more elastomeric polymer materials are preferably added to the pigmented sealant base blend by (1) increasing the temperature of the pigmented sealant base blend to a temperature in the range of from about 350° F. to about 385° F., (2) adding the one or more elastomeric polymer materials, preferably with low shear agitation or mixing, while maintaining a temperature of from about 350° F. to about 385° F., and (3) continuing the low shear agitation or mixing at a temperature of from about 350° F. to about 385° F. until complete dissolution of the polymer material(s) is achieved (typically at least 6 hours).

As noted above, some or all of the distilled tall oil, distilled tall oil blend, and/or other LTP additive can alternatively be added to the inventive non-asphaltic sealant composition after the addition of the polymer material. If added at this point, the addition of the distilled tall oil, distilled tall oil blend, and/or other LTP additive will preferably occur with continued low shear mixing or agitation at the polymer blending temperature, or at a temperature of from 275° F. to 350° F., after the complete dissolution of the polymer material(s).

Once prepared, the inventive non-asphaltic sealant composition can be applied to cracks or joints in a concrete or asphalt substrate surface using generally any of the hot-application procedures and devices used for applying asphalt-based sealants.

The following example is provided for purposes of illustration and is not intended to limit the invention in any way.

### EXAMPLE

Eight hot-applied non-asphaltic sealant compositions (S1-S8) were prepared as identified in Table 1 with all component amounts listed in Table 1 being expressed as percentages by weight based upon the total weight of the entire composition. The compositions were prepared using the inventive method described above under identical blending conditions.

For comparison purposes, no distilled tall oil or other LTP additive was used in composition S1. In compositions S2-S5, distilled tall oil (ALTAPYNE M-28B) was added in the first step of the blending process, i.e., during the formation of the sealant base blend comprising the tree rosin ester, the processing oil (HYDROLENE LPH), and the EMS-100 plasticizer. Composition S6 was identical to composition S4 except that the distilled tall oil was not added until the end of the blending process after the complete dissolution of the polymer.

Composition S7 was identical to composition S4 except that the 6.3% by weight of distilled tall oil used in composition S4 was replaced in composition S7 with an additional 6.3% by weight of epoxidized methyl ester of soybean oil (EMS-100). Similarly, composition S8 was identical to composition S4 except that the 6.3% by weight of distilled tall oil used in composition S4 was replaced in composition S8 with 6.3% by weight of crude soybean oil.

TABLE 1

| | | Mass % | | | | | | | |
|---|---|---|---|---|---|---|---|---|---|
| Component | Source | S1 | S2 | S3 | S4 | S5 | S6 | S7 | S8 |
| Tree Rosin Ester | Ingevity Westrez | 50.6 | 25.3 | 38.0 | 44.3 | 47.5 | 44.3 | 44.3 | 44.3 |
| | 5101 | | | | | | | | |
| Aromatic Oil | Hydrolene LPH | 26.4 | 26.4 | 26.4 | 26.4 | 26.4 | 26.4 | 26.4 | 26.4 |
| Distilled Tall Oil | Ingevity Altapyne | 0.0 | 25.3 | 12.6 | 6.3 | 3.1 | 6.3 | 0.0 | 0.0 |
| | M28B | | | | | | | | |
| Crude Soybean | ADM | 0.0 | 0.0 | 0.0 | 0.0 | 0.0 | 0.0 | 0.0 | 6.3 |
| Oil | | | | | | | | | |
| Plasticizer | ACS EMS100 | 2.5 | 2.5 | 2.5 | 2.5 | 2.5 | 2.5 | 8.8 | 2.5 |
| TiO2 | PL Industries, | 8.0 | 8.0 | 8.0 | 8.0 | 8.0 | 8.0 | 8.0 | 8.0 |
| | Rutile | | | | | | | | |
| Blue Pigment | PL Industries ME- | 0.6 | 0.6 | 0.6 | 0.6 | 0.6 | 0.6 | 0.6 | 0.6 |
| | 2384 | | | | | | | | |
| Black Pigment | Gilsonite HMA | 0.4 | 0.4 | 0.4 | 0.4 | 0.4 | 0.4 | 0.4 | 0.4 |
| Polymer | Dynasol 411 SBS | 11.5 | 11.5 | 11.5 | 11.5 | 11.5 | 11.5 | 11.5 | 11.5 |

The performance parameters measured for compositions S1-S8 are provided in Table 2.

TABLE 2

| Sample # | S1 | S2 | S3 | S4 | S5 | S6 | S7 | S8 |
|---|---|---|---|---|---|---|---|---|
| 350° F. Viscosity | 5600 | 1325 | 2625 | 3525 | 4737 | 3837 | 3762 | 3812 |
| (cps) | | | | | | | | |
| Soft Point (° C.) | 83.5 | 71.5 | 76 | 79 | 81 | 79 | 67.5 | 74 |
| 25° C. Cone | 59 | 130 | 115 | 105 | 83 | 100 | 107 | 108 |
| Penetration | | | | | | | | |
| Resilience (%) | 65 | 100 | 96 | 89 | 91 | 100 | 93 | 84 |
| 4° Ductility (cm) | 46.5 | Pulled | 81 | 77 | 67 | 76.5 | 85 | 81.5 |
| | | out of | | | | | | |
| | | mold | | | | | | |
| BBR Creep | 79.6 | Too soft | Too soft | 2.81 | 19.7 | 2.19 | Too soft | Beam |
| Stiffness, 12° C., 240 | | to test | to test | | | | to test | deflection |
| sec (Mpa) | | | | | | | | beyond range |

As seen in Table 2, the low temperature properties of non-asphaltic sealant composition S1 were not ideal, and the viscosity of the composition was high. The 4° C. ductility of composition S1 was only 46.5 cm and the BBR Creep Stiffness of S1 at −12° C. and 240 sec was high (79.6 MPa).

The amount of distilled tall oil used in S2 (25.3% by weight) was found to be slightly excessive for this particular composition and for the specific distilled tall oil product used in S2.

The low temperature properties and the viscosities of the inventive non-asphaltic sealant compositions S3-S6 were unexpectedly improved to a surprising degree over the low temperature properties and viscosity of the comparative sealant composition S1. Inventive composition S3, which comprised 12.6% by weight of distilled tall oil, had a reduced viscosity of just 2625 cps at 350° F., a 4° C. ductility of 81, and had a reduced stiffness that was too soft for the BBR Creep Stiffness test. Inventive composition S4, which comprised 6.3% by weight distilled tall oil, had a reduced viscosity of just 3525 cps, a 4° C. ductility of 77, and a BBR Creep Stiffness of just 2.81. Inventive composition S5, which comprised just 3.1% by weight distilled tall oil, had a reduced viscosity which was still below 5000 cps, a 4° C. ductility of 67, and a significantly improved BBR Creep Stiffness, as compared to 51, of just 19.7. The properties of inventive composition S6 were very close to those of composition S4, which also had a distilled tall oil concentration of 6.3% by weight.

Importantly, the softening points of the inventive compositions S3-S6, particularly the inventive compositions S4-S6, were substantially maintained at about 80° C. or slightly above which, as noted above, is particularly desirable for non-asphaltic sealant compositions. In addition, the cone penetration and resilience values of each of the inventive compositions S3-S6 were significantly improved.

The improvements in low temperature properties, viscosities, cone penetration values, and resilience values for inventive compositions S7 and S8 using 6.3% of epoxidized methyl ester of soybean oil (EMS-100) or crude soybean oil rather than distilled tall oil were similar to the improvements provided by the inventive compositions S4 and S6 using 6.3% distilled tall oil. However, unlike the compositions using distilled tall oil, the softening points of compositions S7 and S8 were diminished to values significantly below the desired softening point values for non-asphaltic sealant compositions of about 80° C. or greater as discussed above.

The significant improvement in low temperature and other properties provided by the addition of distilled tall oil in accordance with the present invention, while maintaining the desired softening point of about 80° C. or greater, was surprising and unexpected.

Without being bound by any theory regarding the reason for this unexpected and surprising improvement, we believe that a unique and heretofore unrecognized chemical compatibility exists between the distilled tall oil and the tree rosin ester used in the inventive non-asphaltic sealant composition whereby the distilled tall oil operates to permanently and irreversibly plasticize the tree rosin ester in a manner which provides superior flexibility at low temperatures while maintained a softening point of about 80° C. or higher which is greatly advantageous for non-asphaltic crack and joint sealant compositions.

Similarly, the same improvement in low temperature properties and reduced viscosity which resulted from the addition of distilled tall oil or other LTP additives (most preferably the addition of distilled tall oil) to the inventive non-asphaltic sealant composition will also be produced in other hot-applied non-asphaltic compositions formed from tree rosin esters. Such other compositions include, but are not limited to, thermoplastic pavement markings, dense and gap-graded mixtures of aggregates and non-asphaltic binders, and pothole fillers and patches.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within the invention as defined in the claims.

What is claimed is:

1. A non-asphaltic composition for use as a hot-applied sealant, or for pavement markings, or for use as a binder for aggregates for filling potholes and road repairs, the non-asphaltic composition comprising:
a non-asphaltic base blend which includes
one or more processing oils in a total amount in a range of from 5% to 35% by weight based on a total weight of the non-asphaltic composition,
one or more plasticizers in a total amount in a range of from 0.5% to 6% by weight based on the total weight of the non-asphaltic composition, and
one or more tree rosin esters in a total amount in a range of from 25% to 80% by weight based on the total weight of the non-asphaltic composition and
a low temperature property enhancing additive which (i) is incorporated when and/or after the non-asphaltic base blend is formed, (ii) is selected from a distilled tall oil, a distilled tall oil blend, one or more vegetable oils, or a combination thereof, and (iii) is included in the non-asphaltic composition in a total amount, in a range of from 1% to 25% by weight based on the total weight of the non-asphaltic composition, which increases a 4° C. ductility and decreases a flexural creep stiffness of the non-asphaltic composition.

2. The non-asphaltic composition of claim 1 further comprising the total amount of the low temperature property enhancing additive also increasing a resilience and reducing a viscosity of the non-asphaltic composition.

3. The non-asphaltic composition of claim 2 further comprising the total amount of the low temperature property enhancing additive (i) not reducing a softening point of the non-asphaltic composition below 79° C., (ii) maintaining the softening point of the non-asphaltic composition at a value of 80° C. or greater, or (iii) increasing the softening point of the non-asphaltic composition.

4. The non-asphaltic composition of claim 1 further comprising:
a total of from 1% to 25% by weight, based on the total weight of the non-asphaltic composition, of one or more color neutralizing materials which at least partially neutralize a non-white shade or color of the non-asphaltic base blend and
a total of from 0.1% to 6% by weight, based on the total weight of the non-asphaltic composition, of one or more pigment materials which impart a non-white color or shade to the non-asphaltic composition.

5. The non-asphaltic composition of claim 4 further comprising:
the one or more color neutralizing materials comprising titanium dioxide and
the one or more pigment materials comprising Gilsonite which imparts a gray color to the non-asphaltic composition.

6. The non-asphaltic composition of claim 1 further comprising a total of from 2% to 20% by weight, based on the total weight of the non-asphaltic composition, of one or more elastomeric polymer materials.

7. The non-asphaltic composition of claim 1 further comprising the low temperature property enhancing additive being the distilled tall oil or the distilled tall oil blend.

8. The non-asphaltic composition of claim 7 further comprising the low temperature property enhancing additive, which is the distilled tall oil or the distilled tall oil blend, comprising (i) one or more rosin acids in a total amount of from 10% to 50% by weight based on a total weight of the distilled tall oil or the distilled tall oil blend and (ii) one or more fatty acids in a total amount of from 60% to 90% by weight based on the total weight of the distilled tall oil or the distilled tall oil blend.

9. The non-asphaltic composition of claim 8 further comprising:
the one or more rosin acids comprising abietic acid and/or pimaric acid and
the one or more fatty acids comprising palmitic acid, stearic acid, oleic acid, linoleic acid, and/or linolenic acid.

10. The non-asphaltic composition of claim 8 further comprising:
the one or more rosin acids including each of abietic acid and pimaric acid and
the one or more fatty acids including each of palmitic acid, stearic acid, oleic acid, linoleic acid, and linolenic acid.

11. The non-asphaltic composition of claim 7 further comprising the one or more tree rosin esters being one or more pine-based pentaerythritol ester resins and/or one or more pine-based glycerol ester resins.

12. The non-asphaltic composition of claim 11 further comprising:
the total amount of the one or more tree rosin esters being from 40% to 55% by weight based on the total weight of the non-asphaltic composition and
the total amount of the low temperature property enhancing additive being from 2% to 7% by weight based on the total weight of the non-asphaltic composition.

13. The non-asphaltic composition of claim 1 further comprising the one or more tree rosin esters being one or more pine-based pentaerythritol ester resins.

14. The non-asphaltic composition of claim 1 further comprising the one or more plasticizers comprising one or more epoxidized esters of vegetable oils.

15. The non-asphaltic composition of claim 1 further comprising the one or more plasticizers being one or more epoxidized esters of soybean oil.

16. A method for forming, and enhancing low temperature properties of, a non-asphaltic composition for use as a hot-applied sealant, or for pavement markings, or for use as a binder for aggregates for filling potholes and road repairs, the method comprising steps of:
a) forming a non-asphaltic base blend by heating and blending
one or more processing oils in a total amount in a range of from 5% to 35% by weight based on a total weight of the non-asphaltic composition,
one or more plasticizers in a total amount in a range of from 0.5% to 6% by weight based on the total weight of the non-asphaltic composition, and
one or more tree rosin esters in a total amount in a range of from 25% to 80% by weight based on the total weight of the non-asphaltic composition and
b) incorporating, during and/or after step (a), a low temperature property enhancing additive in a total amount, in a range of from 1% to 25% by weight based on the total weight of the non-asphaltic composition, which increases a 4° C. ductility and decreases a flexural creep stiffness of the non-asphaltic composition, the low temperature property enhancing additive being a distilled tall oil, a distilled tall oil blend, one or more vegetable oils, or a combination thereof.

17. The method of claim 16 further comprising:
the one or more tree rosin esters being one or more pine-based pentaerythritol ester resins and/or one or more pine-based glycerol ester resins and
the low temperature property enhancing additive being the distilled tall oil or the distilled tall oil blend.

18. The method of claim 17 further comprising:
the total amount of the low temperature property enhancing additive incorporated in step (b) also increasing a resilience and reducing a viscosity of the non-asphaltic composition and
the total amount of the low temperature property enhancing additive incorporated in step (b) also (i) not reducing a softening point of the non-asphaltic composition below 79° C., (ii) maintaining the softening point of the non-asphaltic composition at a value of 80° C. or greater, or (iii) increasing the softening point of the non-asphaltic composition.

19. The method of claim 17 further comprising:
the one or more tree rosin esters being one or more pine-based pentaerythritol ester resins and
the low temperature property enhancing additive, which is the distilled tall oil or the distilled tall oil blend, comprising (i) one or more of abietic acid and/or pimaric acid in a total amount of from 10% to 50% by weight based on a total weight of the distilled tall oil or the distilled tall oil blend and (ii) one or more of palmitic acid, stearic acid, oleic acid, linoleic acid, and/or linolenic acid in a total amount of from 60% to 90% by weight based on the total weight of the distilled tall oil or the distilled tall oil blend.

20. The method of claim 16 further comprising, after step (a), one or more of:
adding a total of from 2% to 20% by weight, based on the total weight of the non-asphaltic composition, of one or more elastomeric polymer materials;
adding crumb rubber;
adding a total of from 1% to 25% by weight, based on the total weight of the non-asphaltic composition, of one or more color neutralizing materials which at least partially neutralize a non-white shade or color of the non-asphaltic base blend, the one or more color neutralizing materials comprising at least titanium dioxide; and/or
adding a total of from 0.1% to 6% by weight, based on the total weight of the non-asphaltic composition, of one or more pigment materials which impart a non-white color or shade to the non-asphaltic composition.
